(19) United States
(12) Patent Application Publication
(10) Pub. No.: US 2020/0114695 A1
(43) Pub. Date: Apr. 16, 2020

(54) TIRE TREAD SIDEWALL FEATURES

(71) Applicant: Bridgestone Americas Tire Operations, LLC, Nashville, TN (US)

(72) Inventor: Kevin E. Scheifele, Atwater, OH (US)

(21) Appl. No.: 16/598,431

(22) Filed: Oct. 10, 2019

Related U.S. Application Data
(60) Provisional application No. 62/746,023, filed on Oct. 16, 2018.

(51) Int. Cl. B60C 11/11; B60C 11/04

(52) U.S. Cl. CPC B60C 11/11; B60C 2011/039; B60C 11/04

(57) ABSTRACT

A tire comprising a tread is provided, the tread having a first rib and a second rib. A plurality of axial grooves traverse each rib, dividing each rib into a plurality of tread blocks. Further, each tread block includes one or more block sidewalls and a block tread surface. A circumferential groove is positioned between the first rib and the second rib, which includes a groove bottom bound by the one or more block sidewalls. In addition, a first protrusion is positioned on a first block sidewall of a tread block of the first rib, wherein the first protrusion has a first top surface, and the first top surface is radially offset from the block tread surface. Further, the first protrusion has a first radial surface that extends radially inward from the first top surface at a first angle. Likewise, a second protrusion is positioned on a second block sidewall of a tread block of the second rib, wherein the second protrusion has a second top surface, and the second top surface is radially offset from the block tread surface. Moreover, the second protrusion has a second radial surface that extends radially inward from the second top surface at a second angle. The second protrusion is positioned substantially opposite to the first protrusion.

### CROSS-REFERENCE TO RELATED APPLICATIONS

This application claims priority to U.S. Provisional Patent Application No. 62/746,023, filed on Oct. 16, 2018, which is incorporated by reference herein in its entirety.

### BACKGROUND

Tires typically encounter a variety of small debris on roads, such as stones from surrounding terrain, ejected from other vehicles, or loose from a material forming the road. When a tire rolls over debris, it may become lodged in a groove of a tread of the tire. An intersection of a circumferential groove and an axial groove are especially vulnerable, and particularly intersections with high void areas. High void areas in the grooves garner stones and other debris as their shape and width can be inadvertently suitable for retaining objects in the tread.

Debris trapped in the tread may impair tire performance, such as increasing pattern noise production, decreasing fuel-efficiency, impeding wet-grip tire performance, and the like. Significantly, debris may damage the tire. For example, debris may contact rubber of a bottom of the groove. Then, upon rotation of the tire, the debris may penetrate into and break down the tread rubber. As a result, belt layers or carcass plies inside the tread rubber may become damaged. Ultimately, this action can lead to puncture of the tire or irreparable damage to the tire.

In addition, tires may be exposed to a variety of road conditions. Such road conditions may include dry, wet, snowy, icy, muddy, rubbly, and the like. A tread of a tire may include certain features to improve performance for a particular road condition. For example, for enhanced snow performance, the tread may include features for optimizing snow traction. Such features may be positioned on a sidewall of a rib of the tread and may be designed to capture and retain snow. The features may comprise one or more of a channel, a passageway, a cut, or any other feature suited for capturing and holding snow. Upon contact with snowy ground, the tread features may hold snow, increasing snow-on-snow friction of the tread, and thereby improving the snow traction of the tire.

What is needed is a tire configured to prevent debris from becoming lodged in grooves of a tread of the tire while maintaining tire performance. Further, what is needed is a tire having tread features for improved snow performance.

### SUMMARY

In one example, a tire comprising a tread is provided, the tread having: a tread having: a first rib; a second rib; a plurality of axial grooves that traverse each rib, dividing each rib into a plurality of tread blocks, wherein each tread block includes one or more block sidewalls and a block tread surface; a circumferential groove positioned between the first rib and the second rib, having a groove bottom bound by the one or more block sidewalls; a first protrusion positioned on a first block sidewall of a tread block of the first rib, wherein the first protrusion has a first top surface, and the first top surface is radially offset from the block tread surface, and wherein the first protrusion has a first radial surface that extends radially inward from the first top surface at a first angle; and a second protrusion positioned on a second block sidewall of a tread block of the second rib, wherein the second protrusion has a second top surface, and the second top surface is radially offset from the block tread surface, wherein the second protrusion has a second radial surface that extends radially inward from the second top surface at a second angle, and wherein the second protrusion is positioned substantially opposite to the first protrusion.

In another example, a tire comprising a tread is provided, the tread having: a plurality of ribs; a plurality of axial grooves that traverse each rib, dividing each rib into a plurality of tread blocks, wherein each tread block includes one or more block sidewalls and a block tread surface, and wherein each of the one or more block sidewalls includes one or more of a substantially axially outward-facing sidewall and one or more of a substantially axially inward-facing sidewall; a plurality of circumferential grooves, each having a circumferential groove bottom bound by the one or more block sidewalls, wherein each of the plurality of circumferential grooves is positioned between two contiguous ribs; a first protrusion positioned on the substantially axially outward-facing block sidewall of a tread block one of the plurality of ribs, wherein the first protrusion has a first top surface, and the first top surface is radially offset from the block tread surface, and wherein the first protrusion has a first radial surface that extends radially inward from the first top surface at a first angle; and a second protrusion positioned on the substantially axially inward-facing block sidewall of a tread block of a contiguous rib, wherein the second protrusion has a second top surface, and the second top surface is radially offset from the block tread surface, wherein the second protrusion has a second radial surface that extends radially inward from the second top surface at a second angle, and wherein the second protrusion is positioned substantially opposite to the first protrusion.

In a further example, a tire comprising a tread is provided, the tread having: opposing shoulder ribs; opposing intermediate ribs; a plurality of axial grooves that traverse each rib, dividing each rib into a plurality of tread blocks, wherein each tread block includes one or more block sidewalls and a block tread surface, and wherein each of the one or more block sidewalls includes one or more of a diagonal and substantially outward-facing block sidewall and one or more of a diagonal and substantially inward-facing block sidewall; a plurality of circumferential grooves, each having a circumferential groove bottom bound by the one or more block sidewalls, wherein each of the plurality of circumferential grooves is positioned between each shoulder rib and each contiguous intermediate rib; a first protrusion positioned on the diagonal and substantially outward-facing block sidewall of a tread block of each intermediate rib; and wherein the first protrusion has a first top surface, and the first top surface is radially offset from the block tread surface, and wherein the first protrusion has a first radial surface that extends radially inward from the first top surface at a first angle; and a second protrusion positioned on the substantially diagonal and inward-facing block sidewall of a tread block of each shoulder rib, wherein the second protrusion has a second top surface, and the second top surface is radially offset from the block tread surface, wherein the second protrusion has a second radial surface that extends radially inward from the second top surface at a second angle, and wherein the second protrusion is positioned substantially opposite to the first protrusion.

### BRIEF DESCRIPTION OF THE DRAWINGS

Features, objects, and advantages other than those set forth above will become more readily apparent when consideration is given to the detailed description below. The detailed description makes reference to the following drawings.

FIG. 1 depicts a partial side perspective view of a tire.

FIG. 2 depicts a partial plan view of the tire of FIG. 1.

FIG. 3 depicts a partial perspective view of the tire of FIG. 2.

FIG. 4 depicts a sectional view of the tire of FIG. 3 along A-A.

FIG. 5 depicts a sectional view of the tire of FIG. 3 along B-B.

FIG. 6 depicts a sectional view of the tire of FIG. 3 along C-C.

FIG. 7 depicts a partial perspective view of the tire of FIG. 2.

FIG. 8 depicts a sectional view of the tire of FIG. 7 along D-D.

FIG. 9 depicts a sectional view of the tire of FIG. 7 along E-E.

FIG. 10 depicts a partial perspective view of the tire of FIG. 2.

FIG. 11 depicts a sectional view of the tire of FIG. 10 along F-F.

FIG. 12 depicts a sectional view of the tire of FIG. 10 along G-G.

### DETAILED DESCRIPTION

The structures illustrated in the drawings include examples of the features recited in the claims. The illustrated structures thus include examples of how a person of ordinary skill in the art can make and use the disclosure claimed. These examples are described to meet the enablement and best mode requirements of the patent statue without imposing limitations that are not recited in the claims. One or more of the features of one example may be used in combination with, or as a substitute for, one or more features of another as needed for any particular implementation of the examples described herein.

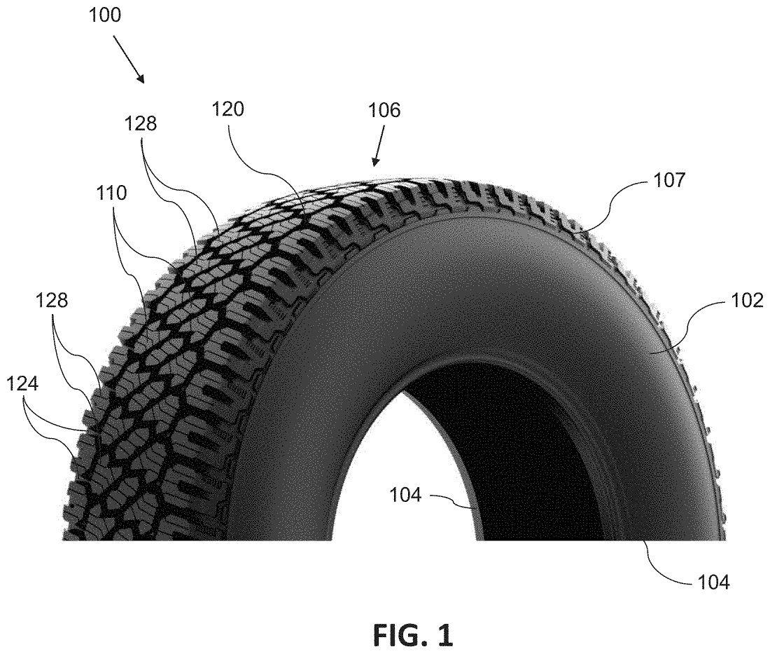

FIG. 1 depicts an example of a tire 100. Tire 100 may be one of a radial tire and a bias ply tire. Tire 100 may include any of a variety of one of a pneumatic tire and a non-pneumatic tire. Tire 100 may be configured for use for one of a passenger tire, a truck tire, a bus tire, an off-the-road tire, an ATV tire, an agricultural tire, and the like. Tire 100 may be configured for use in a tire constructed for operation on a roadway. Tire 100 may be one of a directional tire and a non-directional tire.

Tire 100 may include opposing sidewalls 102. Tire 100 may include opposing bead portions 104. Tire 100 may include a ground-contacting portion oriented between opposing sidewalls 102 that includes a tread 106 having opposing shoulder regions 107. In some instances, “opposing” describes a position of a second feature as to a first feature, such that the second feature is a mirror image of the first feature relative to a circumferential centerline CL (a line of reflection) of tire 100. For example, opposing shoulder regions 108 are a mirror image of each other relative to circumferential centerline CL, such that they are located at substantially identical positions on either side of centerline CL on tire 100. Alternatively, in other instances, “opposing” describes a position of a second sub-feature as to a first sub-feature, such that the second sub-feature is a mirror image of the first feature relative to a desired line of reflection of a feature including the sub-features.

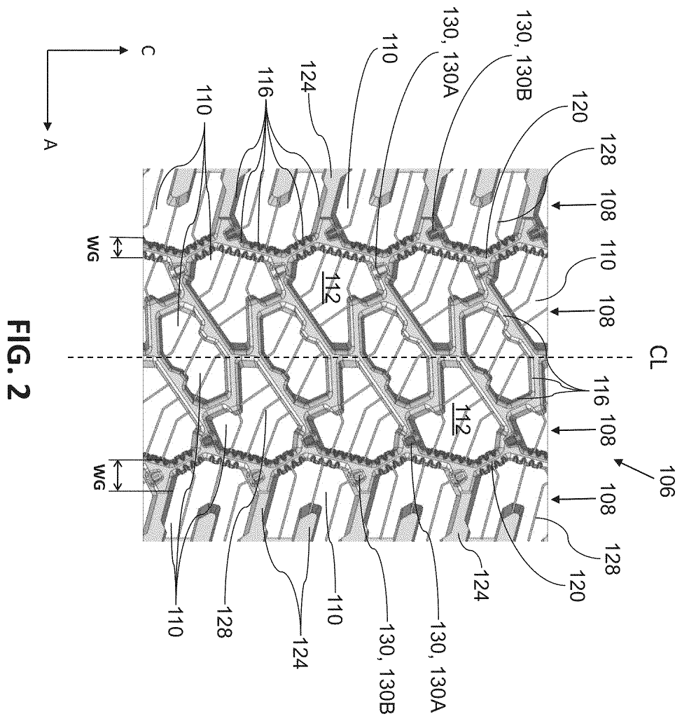

FIGS. 2-7 and 10 include axes identified as “C,” “R,” and “A.” The C-axis is intended to represent a circumferential direction in the tire. The R-axis is intended to represent a radial direction in the tire. The A-axis is intended to represent an axial direction in the tire.

Referring to FIG. 2, tread 106 may include one or more ribs 108. Rib 108 may include any of a variety of ribs within tread 106. In one example, rib 108 is a solid, continuous circumferential rib. “Continuous” describes a feature that extends entirely about or across tire 100, such as a rib 108 that extends about a circumference of tire 100. In another example, rib 108 is a solid, discontinuous circumferential rib. “Discontinuous” describes a feature that extends about or across a portion of tire 100 rather than the entirety of tire 100. In an additional example, rib 108 includes, but is not limited to, one or more of a shoulder rib, an intermediate rib, and a center rib. “Shoulder” describes a rib oriented nearest to shoulder region 107 of tire 100. “Intermediate” describes a rib arranged axially inward from a shoulder rib, yet axially outward from centerline CL of tire 100. “Center” describes a rib oriented substantially along centerline CL of tire 100. A shape of rib 108 may be, but is not limited to, one of substantially linear, linear, zigzag, curved, curvilinear, serpentine, and irregular.

Rib 108 may also include any of a variety of arrangements along tread 106. In one example, as shown in FIG. 2, tread 106 includes opposing shoulder ribs 108, opposing intermediate ribs 108, and a center rib 108. In a further example, tread 106 includes a first rib 108 and a second rib 108. In an additional example, tread 106 includes opposing shoulder ribs 108 and opposing intermediate ribs 108. In examples having a plurality of ribs 108, the plurality of ribs 108 may be one of equally and unequally axially-spaced relative to one another.

Referring to FIGS. 1-6, and as most clearly illustrated in FIG. 2, rib 108 may be divided into a plurality of tread blocks 110. A shape of each tread block 110 may be, but is not limited to, one or more of a square, a rectangle, a parallelogram, and an irregular shape. Tread block 110 may have a block tread surface 112, a block base 114, and one or more block sidewalls 116. Block tread surface 112 is a radially outermost ground-contacting surface of tread block 110. Block base 114 is a radially innermost surface of tread block 110 that interfaces with a carcass of tire 100. Block base 114 may be integral with the carcass of tire 100. Block tread surface 112 and block base 114 may be one of substantially parallel and parallel to one another. Block sidewall 116 extends radially inward from block tread surface 112 to a groove bottom. Block sidewall 116 defines an outer side surface of tread block 110, such as an axially-outer and/or a circumferentially-outer side surface of tread block 110.

An orientation of block sidewall 116 may be, but is not limited to, one of substantially axially outward-facing (away from centerline CL of tire 100), axially outward-facing, substantially axially inward-facing (toward centerline CL of tire 100), axially inward-facing, substantially circumferentially-facing, circumferentially-facing, diagonal (in a C-A plane and inclined relative to the A-axis of a tire) and substantially outward-facing, and diagonal and substantially inward-facing. For example, as illustrated in FIG. 2, each tread block 110 of each shoulder rib 108 includes two opposing substantially circumferentially-facing block sidewalls 116, one substantially axially inward-facing block sidewall 116, and two diagonal and substantially inward-facing block sidewalls 116.

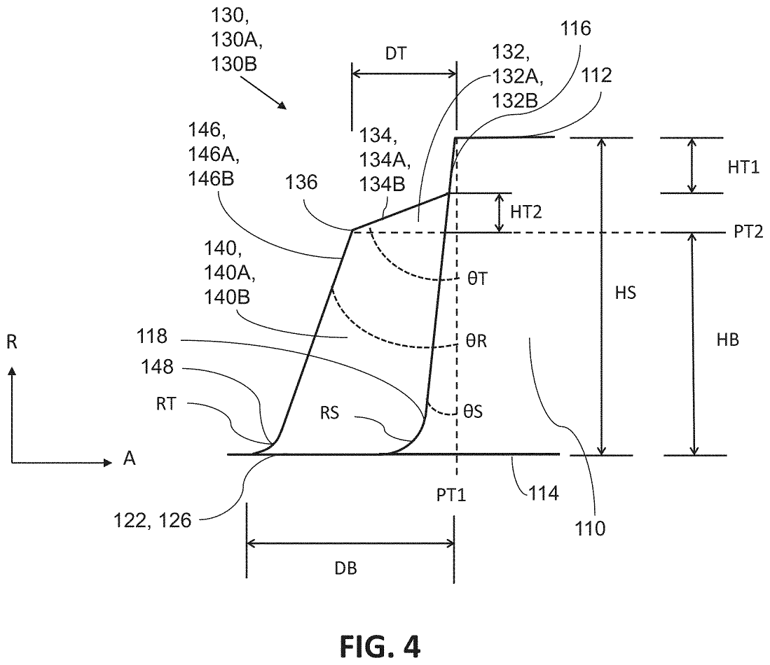

Referring to FIG. 4, block sidewall 116 may include a height H_{S} that is a distance between block tread surface 112 and block base 114 in the radial direction. Height H_{S} may include any of a variety of heights commonly found in tire tread patterns. In one example, height H_{S} is about 8.15 mm. In another example, height H_{S} is 8.15 mm. In a further example, height H_{S} is in a range from about 6.0 mm to about 10.0 mm. Height H_{S} may be any value, for example, 8.20 mm, 8.10 mm, and the like. Additionally, Radius H_{S} may be in a range contained within the aforementioned range, for instance, about 6.4 mm to about 9.1 mm, 8.0 mm to 9.0 mm, and the like.

Furthermore, as shown in FIG. 4, block sidewall 116 may be inclined at an angle θ_{S} relative to a plane P_{T1}. The plane P_{T1} is substantially normal to the tread block surface 112, and spatially, is aligned with a radially outermost edge of block sidewall 116. For example, angle θ_{S} is about 0.0 degrees. In another example, angle θ_{S} is greater than 0.0 degrees. In a further example, angle θ_{S} is about 5.0 degrees. In an additional example, angle θ_{S} is 5.0 degrees. Angle θ_{S} may be any value, for example, 5.2 degrees, 15.0 degrees, 22.1 degrees, and the like. Furthermore, angle θ_{S} may be in a range contained within any of the aforementioned ranges, for example, 0.0 degrees to 15.0 degrees, about 5.0 degrees to about 10.0, about 15.0 degrees to about 20.0 degrees, and the like.

Also illustrated in FIG. 4, block sidewall 116 may further include a sidewall base 118. Sidewall base 118 is a radially inner portion of block sidewall 116 that meets a groove bottom. In some examples, a surface of sidewall base 118 is substantially tangential to the plane P_{T1}, such that it is substantially normal to a groove bottom. In other examples, such as that shown in FIG. 4, the surface of sidewall base 118 has a radius R_{S}, such that it curves outwardly from P_{T1} to a groove bottom.

In one example, radius R_{S} is about 2.5 mm. In a further example, radius R_{S} is 2.5 mm. In a further example, radius R_{S} is about 1.0 mm to about 4.0 mm. Radius R_{S} may be any value, for example, about 1.25 mm, 1.25 mm, about 3.0 mm, 3.8 mm, and the like. Additionally, Radius R_{S} may be in a range contained within any of the aforementioned ranges, for example, about 1.25 mm to about 3.0 mm, 1.5 mm to 3.5 mm, and the like.

Referring to FIGS. 1-3, tread 106 may further include one or more circumferential grooves 120. Circumferential groove 120 may include circumferential groove bottom 122. Circumferential groove bottom 122 includes a portion of circumferential groove 120 that interfaces with the carcass of tire 100. Circumferential groove bottom 122 may be bound by the one or more block sidewalls 116 of the plurality of tread blocks 110.

Circumferential groove 120 may include any of a variety of circumferential grooves within tread 106. In one example, as illustrated in FIGS. 1 and 2, circumferential groove 120 is a continuous circumferential groove. In another example, circumferential groove 120 is a discontinuous circumferential groove. A shape of circumferential groove 120 may be, but is not limited to, one or more of substantially linear, linear, zigzag, curved, curvilinear, serpentine, and irregular.

Circumferential groove 120 may include any of a variety of configurations on tread 106. In one example, a first circumferential groove 120 is contiguous to a second circumferential groove 120. In a further example, a plurality of circumferential grooves 120 may be one of equally and unequally circumferentially-spaced relative to one another. In another example, a plurality of circumferential grooves 120 may be one of substantially circumferentially aligned, circumferentially aligned, and circumferentially skewed relative to one another. “Skewed” describes a plurality of features oriented such that no two features are parallel to one another and no two features intersect one another.

Circumferential groove 120 may have an axial width W_{G}. In one example, as depicted in FIG. 2, width W_{G} varies along a length of circumferential groove 120. In another example, width W_{G} remains constant along the length of circumferential groove 120. Width W_{G} may include any of an assortment of widths. In some examples, width W_{G} includes any of a variety of widths commonly found in tire tread patterns. In such examples, width W_{G} is about 25.0 mm or less. Width W_{G} may be any value, for example, 25.0 mm, 20.0 mm, about 18.2 mm, and the like. Furthermore, width W_{G} may be in a range contained within any of the aforementioned ranges, for example, about 10.0 mm to about 25.0 mm, 12.0 mm to 20.0 mm, and the like.

Circumferential groove 120 and rib 108 may include any of an assortment of configurations on tread 106. In one example, circumferential groove 120 is positioned between a first rib 108 and a contiguous second rib 108. In another example, each of a plurality of circumferential grooves 120 is positioned between contiguous pairs of a plurality of ribs 108. In an additional example, each of a plurality of circumferential grooves 120 is positioned between a shoulder rib 108 and a contiguous intermediate rib 108. In a further example, as illustrated in FIG. 2, each of a plurality of circumferential grooves 120 is positioned between each shoulder rib 108 and a contiguous intermediate rib 108, and further, each intermediate rib 108 and a contiguous center rib 108.

In addition, as shown in FIGS. 1-3, tread 106 may include one or more axial grooves 124. Axial groove 124 may include an axial groove bottom 126. Axial groove bottom 126 may include a portion of axial groove 124 that interfaces with the carcass of tire 100. Axial groove 124 may have a constant width along its length. Axial groove 124 may have a varying width along its length. Width of axial groove 124 may include any of a variety of widths commonly found in tire tread patterns. A shape of axial groove 124 may be, but is not limited to, one or more of substantially linear, linear, zigzag, curved, curvilinear, serpentine, and irregular.

Axial groove 124 and circumferential groove 120 may include any of an assortment of arrangements on tread 106. In one example, axial groove 124 intersects circumferential groove 120. In another example, axial groove 124 intersects circumferential groove to form a triangular-shaped high void area at the intersection. The high void area has greater axial and circumferential dimensions than the width of either of circumferential groove 120 and axial groove 124. The width of the high void area may include, for example, an axial width and/or circumferential width measured at a radial height that is coplanar with block tread surface 112. The high void area may be 1.5 to 2.0 times greater in width than either of the intersecting circumferential groove 120 and axial groove 124.

Axial groove 124 may include any of a variety of configurations on tread 106. In some examples, a plurality of axial grooves 124 traverses rib 108, dividing rib 108 into a plurality of tread blocks 110. In one example, a plurality of axial grooves 124 are arranged to communicate with shoulder region 107, such that the plurality of axial grooves 124 extends substantially axially inward from shoulder region 107, across shoulder rib 108, to a contiguous circumferential groove 120, wherein the plurality of axial grooves 124 intersects circumferential groove 120. In another example, a plurality of axial grooves 124 are positioned to communicate with contiguous circumferential grooves 120, such that the plurality of axial grooves 124 extends across an intermediate rib 108 from a contiguous circumferential groove 120 to another contiguous circumferential groove 120, such that the plurality of axial grooves 124 intersects the contiguous circumferential grooves 120. In a further example, a plurality of axial grooves 124 are positioned to communicate with contiguous circumferential grooves 120, such that the plurality of axial grooves 124 extends across a center rib 108 from a contiguous circumferential groove 120 to another contiguous circumferential groove 120, such that the plurality of axial grooves 124 intersects the contiguous circumferential grooves 120.

In other examples, each of a plurality of axial grooves 124 extends one of substantially axially inward and substantially axially outward from one of a shoulder region 107 and a circumferential groove 120 partially into one of a plurality of tread blocks 110, and thus, terminates within the tread block 110.

Additionally, a plurality of axial grooves 124 may be one of equally and unequally axially-spaced relative to one another. In another example, a plurality of axial grooves 124 may be one of substantially parallel, parallel, or skewed in the axial direction relative to one another.

Additionally, tread 106 may include one or more sipes 128. Sipe 128 may be radially oriented on tread block 110, such that sipe 128 extends radially inward from block tread surface 112 of tread block 110. In one example, sipe 128 extends radially inward from block tread surface 112 and terminates a distance from block base 114. In another example, sipe 128 extends radially inward from block tread surface 112 to block base 114. A shape of sipe 128 may include, but is not limited to, one or more of substantially linear, linear, zigzag, bent, curved, curvilinear, serpentine, and irregular. Also, sipe 128 may include, but is not limited to, one or more of a sipe having a constant width, a varying width, a constant height, a varying height, a constant depth, and a varying depth.

Referring to FIGS. 1-3, sipe 128 may include any of a variety of sipes within tread 106. In one example, sipe 128 is a discontinuous sipe that extends from block sidewall 116 and terminates within tread block 110. In another example, sipe 128 is a discontinuous sipe that extends from within tread block 110 and terminates within tread block 110, such as a mid-sipe having two closed ends within tread block 110. In a further example, sipe 128 traverses tread block 110 such that sipe 128 extends from one block sidewall 116 to any other block sidewall 116 of tread block 110. In an additional example, in any of the prior examples, sipe 128 may extend past block sidewall 116 into one or more of circumferential groove 120, axial groove 124, and an intersection of circumferential groove 120 and axial groove 124.

Sipe 128 may be oriented in any of an assortment of positions on tread block 110. In one example, sipe 128 is oriented in any circumferential position on block tread surface 112. In another example, sipe 128 is oriented in any axial position on block tread surface 112. In a further example, sipe 128 is oriented in any axial and any circumferential position on block tread surface 112. Regarding a relative position, in examples having a plurality of sipes 128, the plurality of sipes 128 may be one of equally and unequally spaced relative to one another along block tread surface 112.

Sipe 128 may include any orientation on block tread surface 112. In one example, sipe 128 extends in the axial direction. In another example, sipe 128 extends in the circumferential direction. In a further example, sipe 128 extends at an angle relative to one of the axial direction and the circumferential direction. As to relative orientation, in examples having a plurality of sipes 128, the plurality of sipes 128 may be one of substantially parallel, parallel, substantially perpendicular, and perpendicular relative to one another on block tread surface 112. Alternatively, the plurality of sipes 128 may be skewed relative to one another on block tread surface 112.

Specifically, in an example as shown in FIG. 2, each tread block 110 of each shoulder rib 108 includes a plurality of substantially parallel sipes 128 that traverses each tread block 110 at an angle relative to the axial direction at upper, middle, and lower circumferential positions. Also referring to FIG. 2, in another example, sipe 128 traverses a discrete portion of tread block 110. Namely, each tread block 110 of each intermediate rib 108 includes a sipe 128 that traverses a corner of tread block 110.

Referring to FIGS. 2-4, tread 106 may further include one or more protrusions 130. Protrusion 130 may be positioned along one or more block sidewalls 116 of one or more tread blocks 110. Protrusion 130 may be integral to tread block 110, such tread block 110 shares a portion of block sidewall 116 with protrusion 130. Accordingly, the side of protrusion 130 that interfaces with tread block 110 is a portion of block sidewall 116. In this configuration, protrusion 130 is positioned as a buttress, and projects from block sidewall 116 into one of a circumferential groove 120, an axial groove 124, and an intersection of a circumferential groove 120 an axial groove 124.

The buttress-like design of protrusion 130 increases a stability and a structural stiffness of tread block 110, such that protrusion 130 reinforces block sidewall 116, providing both circumferential and axial structural stiffness to tread block 110. Specifically, protrusion 130 counteracts circumferential and axial forces exerted on tire 100, preventing a deformation of block sidewall 116, and transferring such forces to one of a circumferential groove bottom 122 and an axial groove bottom 126.

Additionally, prior art stone rejector tread features are typically arranged entirely within one of a circumferential groove and an axial groove. Thus, prior art stone rejector tread features have a plurality of free sides, wherein no free side abuts or is integral to a block sidewall. A free side may be positioned near one or more block sidewalls and one or more free sides of another stone rejector tread feature, creating a plurality of gaps within a groove. A stone or other debris may become easily trapped within one or more of the gaps. Furthermore, in this arrangement, prior art stone rejector tread features may obstruct a flow of one or more of water, mud, and other fluids through a groove, reducing wet traction of a tread.

In contrast, because protrusion 130 extends from block sidewall 116, protrusion 130 does not create gaps between it and a block sidewall 116 or another protrusion 130 within a groove. Thus, protrusion 130 is less likely to contribute to holding stones and debris in a circumferential groove 120 or an axial groove 124. Similarly, the design of protrusion 130 minimizes a surface area of protrusion 130 as compared to prior art stone rejector tread feature. This reduction in surface area diminishes any resistance one of or more of water, mud, and other fluids may experience as they flow through tread 106 and lessens an opportunity for one or more of stones, mud, and other debris from being caught in tread 106. Accordingly, protrusion 130 allows a practical amount of one or more of water, mud, and other fluids to easily flow through void areas of tread 106 and effectively discharge from tread 106. This improves a contact length and a contact area of tread 106 on wet ground, thereby improving traction of tire 100.

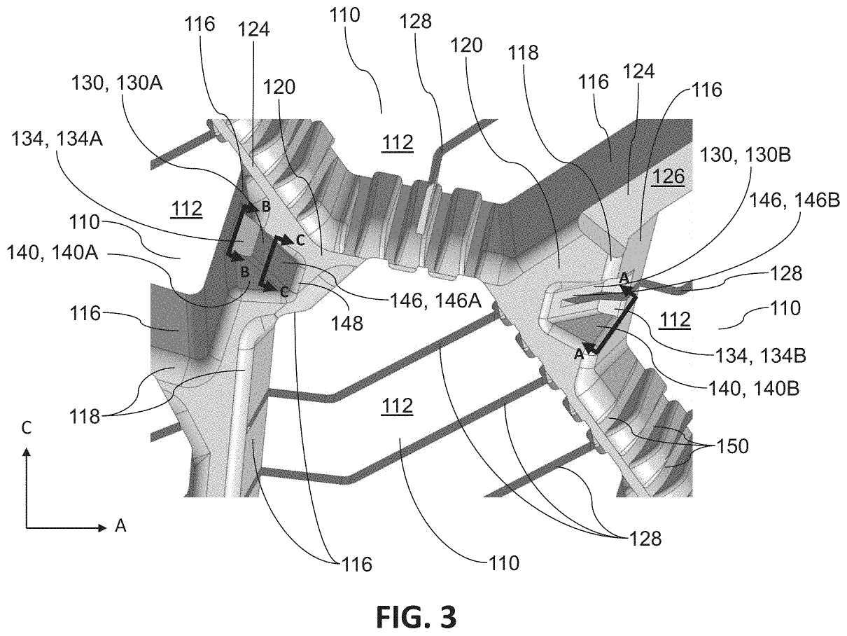

Referencing FIGS. 3 and 4, protrusion 130 may include a top portion 132 having a top surface 134. A radially outermost edge of top surface 134 may be one of radially aligned with and radially offset from block tread surface 112. In one example, the radially outermost edge top surface 134 is radially aligned with block tread surface 112. In another example, as depicted in FIGS. 3-5, the radially outermost edge of top surface 134 is radially offset at a height H_{T1} from block tread surface 112, such that top surface 134 does not intersect block tread surface 112.

As illustrated in FIG. 4, height H_{T1} is a distance from block tread surface 112 radially inward to the radially outermost edge of top surface 134 along plane P_{T1}. In one example, height H_{T1} is about 5.0 mm. In an additional example, height H_{T1} is 5.0 mm. In a further example, height H_{T1} is greater than or equal to 1.0 mm. In an additional example, height H_{T1} is in a range of about 1.0 mm to about 7.0 mm. Height H_{T1} may be any value, for example, about 2.0 mm, 3.4 mm, 6.1 mm, and the like. Furthermore, height HT may be in a range contained within any of the aforementioned ranges, for example, about 2.0 mm to about 4.0 mm, 3.0 mm to 6.7 mm, and the like.

In examples where the radially outermost edge of top surface 134 is radially offset from block tread surface 112 at height H_{T1}, such a configuration maintains an intended amount of void surface area of tread 106. Further, having an offset height H_{T1} of top surface 134 prevents protrusion 130 from impeding a flow of one or more of water, mud, and other fluids through volume void areas of tread 106. Thus, the one or more of water, mud, and other fluids are effectively channeled and ejected from tread 106 improving the wet traction of tire 100.

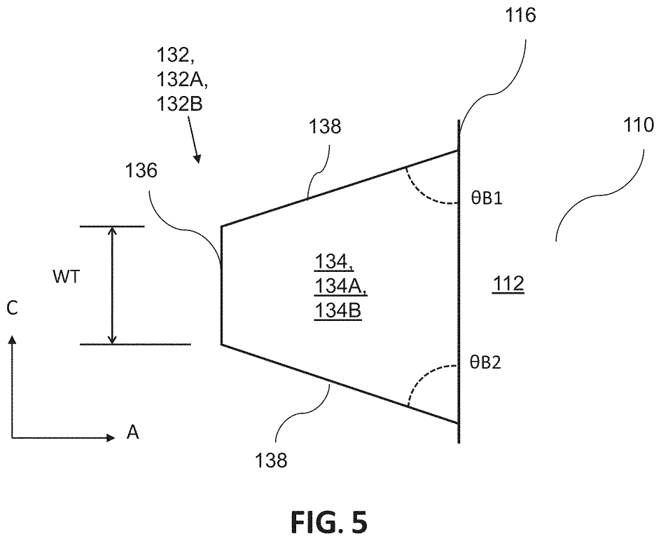

In addition, as represented in FIG. 5, top surface 134 may correspond to a section of top portion 132. A geometry of top surface 134 may include any of a variety of geometries having four or more sides. In an example having four sides, the four sides correspond to a front edge 136 connected to opposing side edges 138, which connect to a portion of block sidewall 116 of tread block 110. Front edge 136 may be offset from block sidewall 116 such that it is oriented outwardly from block sidewall 116. Side edges 138 may extend from opposing ends of front edge 136 and intersect the portion of block sidewall 116 of tread block 110. In addition, side edges 138 may correspond to opposing and radially-extending sidewalls of protrusion 130 that are tangential to top surface 134 and block sidewall 116. The radially-extending sidewalls of protrusion 130 may be one of parallel and sloped relative to the radial direction.

Each side edge 138 may intersect block sidewall 116 of tread block 110 at a base angle of θ_{B1} and θ_{B2}, respectively. Base angles θ_{B1} and θ_{B2} are interior angles of the geometry of top surface 134, measured from within the geometry, from a respective side edge 138 to block sidewall 116. Base angles θ_{B1} and θ_{B2} may be one of congruent and non-congruent angles. In one example, the geometry of top surface 134 is an isosceles trapezoid having base angles θ_{B1} and θ_{B2} of about 75.0 degrees. In another example, the geometry of top surface 134 is an isosceles trapezoid having base angles θ_{B1} and θ_{B2} of 75.0 degrees. In a further example, the geometry of top surface 134 is an isosceles trapezoid having base angles θ_{B1} and θ_{B2} in a range of about 50.0 degrees to about 85.0 degrees. In an additional example, the geometry of top surface 134 is a parallelogram having base angles θ_{B1} and θ_{B2}, which may be one of an acute angle and a right angle, and which may be one of congruent or non-congruent angles. Base angles θ_{B1} and θ_{B2} of the geometry of top surface 134 may be any value, for instance, about 80.0 degrees, 52.4 degrees, 68.0 degrees, and the like. Furthermore, base angles θ_{B1} and θ_{B2} of the geometry of top surface 134 may include a range contained within any of the aforementioned ranges, for example, about 60.2 degrees to about 72.0 degrees, 55.0 degrees to 84.6 degrees.

Furthermore, referring to FIG. 4, top surface 134 may be sloped at an angle θ_{T} relative to plane P_{T1}. Angle θ_{T} is an angle measured from top surface 134 to plane P_{T1}. In one example, angle θ_{T} is about 0.0 degrees. In another example, angle θ_{T} is greater than 0.0 degrees. In an additional example, angle θ_{T} is about 60.0 degrees. In a further example, angle θ_{T} is 60.0 degrees. In another example, angle θ_{T} is in a range of greater than 0.0 degrees to about 60.0 degrees. Angle θ_{T} may be of any value, for example, about 0.8 degrees, 35.0 degrees, 58.9 degrees, and the like. Furthermore, angle θ_{T} may be in a range contained within any of the aforementioned ranges, for instance, about 12.0 degrees to about 42.0 degrees, 35.0 degrees to 58.0 degrees, and the like.

Additionally, top surface 134 may include any of a variety of topographies such as, but not limited to, one or more of substantially flat, flat, concave, and convex. In one example, top surface 134 is substantially flat. In another example, top surface 134 is flat. In a further example, top surface 134 is concave. In an additional example, top surface 134 is convex.

As illustrated in FIG. 4, top portion 132 may include a height H_{T2}. Height H_{T2} is a distance from a radially outermost point of top portion 132 radially inwardly to a plane P_{T2}. Plane P_{T2} has an orientation that is substantially parallel to block tread surface 112, but spatially, is radially aligned with front edge 136 of top surface 134. In an example, height H_{T2} is about 1.73 mm. In a further example, height H_{T2} is 1.73 mm. In another example, height H_{T2} is in a range of about 1.0 mm to about 3.0 mm. Height H_{T2} may be any value, for example, about 2.2 mm, 1.69 mm, and the like. In addition, height H_{T2} of the top portion 120 may be in a range contained within any of the aforementioned ranges, for instance, about 1.5 mm to about 2.5 mm, 1.3 mm to 2.9 mm, and the like.

Also depicted in FIG. 4, top portion 132 may include a depth DT. Depth DT is a distance from plane P_{T1}, along plane P_{T2}, to front edge 136 of top surface 134. In an example, depth DT is greater than about 0.0 mm. In a further example, depth DT is about 3.0 mm. In an additional example, depth DT is 3.0 mm. In another example, depth DT is in a range of about 1.0 mm to about 5.0 mm. Depth DT may be any value, for example, about 3.3 mm, 2.9 mm, 5.1 mm, and the like. Furthermore, depth DT may include a range contained within any of the aforementioned, for instance, about 1.4 mm to about 4.0 mm, 0.8 mm to 5.3 mm, and the like.

Moreover, referring to FIG. 5, top portion 132 may include a width W_{T}. Width W_{T} is a length of front edge 136 of top surface 134. In one example, width W_{T} is about 3.5 mm. In an additional example, width W_{T} is 3.5 mm. In another example, width W_{T} is in a range of about 1.0 mm to about 5.0 mm. In a further example, width W_{T} is greater than 1.0 mm. Width W_{T} may be any value, for instance, about 4.5 mm, 3.4 mm, 5.0 mm, and the like. Furthermore, width W_{T} may include a range contained within any of the aforementioned ranges, for example, about 2.0 mm to about 4.0 mm, 1.4 mm to 5.0 mm, and the like.

Referring again to FIG. 4, protrusion 130 may also include a body portion 140 located radially inward from top portion 132. Body portion 140 may be integral with top portion 132, such that top portion 132 and body portion 140 seamlessly form protrusion. Body portion 140 may include a section having a geometry. In some examples, the geometry of the section of body portion 140 is substantially the same as the geometry of top surface 134.

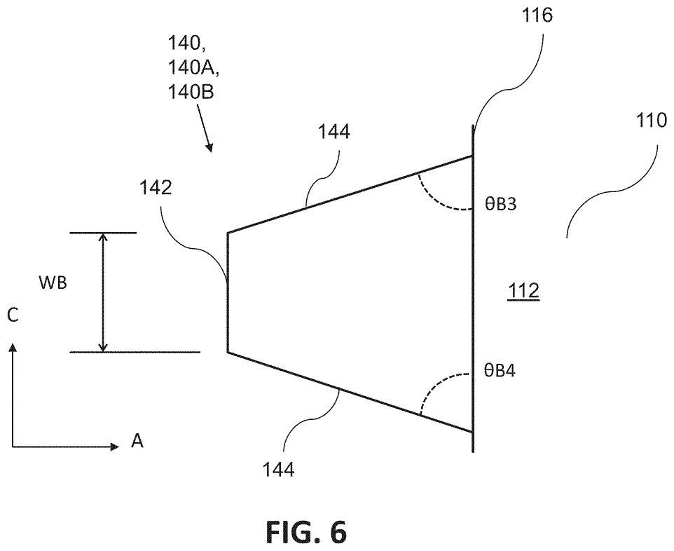

Like top surface 134, the geometry of the section of body portion 140 may include any of a variety of geometries having four or more sides. In an example having four sides, illustrated in FIG. 6, the four sides correspond to a front edge 142 connected to opposing side edges 144, which connect to a portion of block sidewall 116 of tread block 110. Front edge 142 may be offset from block sidewall 116 such that it is oriented outwardly from block sidewall 116 within one of a circumferential groove 120 and an axial groove 124. Side edges 144 may extend from opposing ends of front edge 142 and intersect the portion of block sidewall 116 of tread block 110. Further, similar to top surface 134, side edges 144 may correspond to opposing and radially-extending sidewalls of protrusion 130 that are tangential to a radial surface 146 and block sidewall 116. The radially-extending sidewalls of protrusion 130 may be one of parallel and sloped relative to the radial direction.

Each side edge 144 may intersect block sidewall 116 of tread block 110 at a base angle of θ_{B3} and θ_{B4}, respectively. Base angles θ_{B3} and θ_{B4} are interior angles of the section of body portion 140, measured from within the section, from a respective side edge 144 to block sidewall 116. Base angles θ_{B3} and θ_{B4} may be one of congruent and non-congruent angles. In one example, base angles θ_{B3} and θ_{B4} are about 75.0 degrees. In another example, base angles θ_{B3} and θ_{B4} are 75.0 degrees. In a further example, base angles θ_{B3} and θ_{B4} are about 50.0 degrees to about 85.0 degrees. Base angles θ_{B3} and θ_{B4} may be any value, for instance, about 81.0 degrees, 56.4 degrees, 68.5 degrees, and the like. Furthermore, base angles θ_{B3} and θ_{B4} may include a range contained within any of the aforementioned ranges, for example, about 62.0 degrees to about 75.0 degrees, 50.0 degrees to 86.0 degrees, and the like.

Body portion 140 may include a height H_{B}. As shown in FIG. 4, height H_{B} is a distance from plane P_{T2} radially inwardly along plane P_{T1} to block base 124. In one example, height H_{B} is about 15.0 mm. In an additional example, height H_{B} is 15.0 mm. In a further example, height H_{B} is greater than or equal to about 10.0 mm. In an additional example, height H_{B} is in a range of about 10.0 mm to about 20.0 mm. Height H_{B} may be any value, for instance, about 12.0 mm, 15.1 mm, and the like. Furthermore, height H_{B} may be in a range contained within any of the aforementioned ranges, for instance, about 11.0 mm to about 16.3 mm, 15.0 mm to 19.0 mm, and the like.

A total height of protrusion 130, which would be height H_{T2} of top portions 132 and height H_{B} of body portion 140 cumulatively, may account for about 75.0 percent of height H_{S} of block sidewall 116. The total height of protrusion 130 may be greater or less than 75.0 percent of height H_{S} of block sidewall 116.

In addition, body portion 140 may include a width W_{B}. As depicted in FIG. 6, similar to top portion 132, width W_{B} of body portion 140 is a length of the front edge 142 of body portion 140. Width W_{B} may be one of substantially the same and substantially different from width W_{T} of top surface 134. In one example, width W_{B} is about 3.5 mm. In a further example, width W_{B} is 3.5 mm. In another example, width W_{B} is in a range of about 1.0 mm to about 5.0 mm. In an additional example, width W_{B} is greater than 1.0 mm. Width W_{B} of body portion 140 may be any value, for example about 2.3 mm, 5.1 mm, and the like. Furthermore, width W_{B} of body portion 140 may include a range contained within any of the aforementioned ranges, for instance, about 2.0 mm to about 4.5 mm, 0.8 mm to 5.1 mm, and the like.

Additionally, body portion 140 may include a radial surface 146 that extends radially inward from top surface 134 to about one of circumferential groove bottom 122, axial groove bottom 126, and an intersection of a circumferential groove bottom 122 and an axial groove bottom 126. Radial surface 146 may face one of circumferential groove 120, axial groove 124, and an intersection of a circumferential groove 120 and an axial groove 124. As shown in FIG. 4, radial surface 146 may be sloped at an angle θ_{R} relative to plane P_{T1}. As such, angle θ_{R} is an angle measured from plane P_{T1} to radial surface 146. In one example, angle θ_{R} is 0.0 degrees. In another example, angle θ_{R} is greater than 0.0 degrees. In a further example, angle θ_{R} is in a range of about 5.0 degrees to about 45.0 degrees. In an additional example, angle θ_{R} is greater than about 5.0 degrees. Angle θ_{R} may be of any value, for instance, about 10.0 degrees, about 0.1 degrees, 110.0 degrees, and the like. Furthermore, angle θ_{R} may be in a range contained within any of the aforementioned about 10.0 degrees to about 60.0 degrees, 5.1 degrees to 45.2 degrees, and the like.

Furthermore, radial surface 146 may include any of a variety of topographies such as one or more of substantially flat, flat, concave, and convex. In one example, radial surface 146 is substantially flat. In another example, radial surface 146 is flat. In a further example, radial surface 146 is concave. In an additional example, radial surface 146 is convex.

In addition, as illustrated in FIG. 4, body portion 140 may include a tread skid surface 148 that extends substantially radially inward from radial surface 146 to one of circumferential groove bottom 122, axial groove bottom 126, and an intersection of a circumferential groove bottom 122 and an axial groove bottom 126. In some examples, tread skid surface 148 is substantially normal to a groove bottom. In other examples, tread skid surface 148 has a radius R_{T}, such that it curves outwardly to a groove bottom.

In one example, radius R_{T} is about 1.0 mm. In another example, radius R_{T} is 1.0 mm. In a further example, radius R_{T} is a range from about 0.0 mm to about 3.0 mm. Radius R_{T} may be any value, for example, about 1.7 mm, 0.9 mm, and the like. Furthermore, radius R_{T} may include a range contained within any of the aforementioned ranges, for instance, about 0.5 mm to about 2.5 mm, 0.2 mm to 3.1 mm, and the like.

Body portion 140 may further include a depth D_{B}. Referring to FIG. 4, depth D_{B} is a distance from plane P_{T1} along a groove bottom to tread skid surface 148. In an example, depth D_{B} is greater than DT. In a further example, depth D_{B} is about 7.0 mm. In an additional example, depth D_{B} is 7.0 mm. In another example, depth D_{B} is in a range of about 5.0 mm to about 8.0 mm. Depth D_{B} may be any value, for example, about 6.2 mm, 8.1 mm, and the like. Furthermore, depth D_{B} may include a range contained within any of the aforementioned ranges, for instance, about 6.0 mm to about 7.0 mm, 4.9 mm to 8.2 mm, and the like.

Protrusion 130 includes a variety of advantages over conventional stone ejector tread features. Because protrusion 130 extends from block sidewall 116 of tread block 110 and its top surface 134 and radial surface 146 are angled, protrusion 130 does not require a mold vent, and therefore, efficiently and effectively fills with rubber during a molding process of tire 100. In addition, in light of offset height H_{T1} of top surface 134, height H_{T2} and width W_{T} of top portion 132, and height H_{B} and width W_{B} of body portion 140, protrusion 130 includes a larger height and volume than prior art stone rejector tread features. This larger relative size of protrusion 130 offers greater protection to tread 106, namely, preventing stones and other debris from becoming lodged in one of a circumferential groove 120, an axial groove 124, and an intersection of a circumferential groove 120 and an axial groove 124. As a result, protrusion 130 maintains an integrity of tire 100 and increases a lifetime of tire 100.

Additionally, as tread block 110 shares a portion of block sidewall 116 with protrusion 130, a stability of protrusion 130 is enhanced. As a result, protrusion 130 is stiffer than conventional stone ejector tread features, and the radially-extending sidewalls that correspond to side edges 138 and 144 of protrusion 130 may contribute to increased traction in tread performance of tire 100. Moreover, the slope of the radially-extending sidewalls that correspond to side edges 138 and 144 of protrusion 130 may assist in maintaining a volume void area in tread 106, and simultaneously, ease the flow of one or more of water, mud, and other fluids passing through one of a circumferential groove 120, an axial groove 124, and an intersection of a circumferential groove 120 and an axial groove 124 over protrusion 130.

As shown in FIGS. 2 and 3, protrusion 130 may include different types. In some examples, protrusion 130 includes two types, a first protrusion 130A and a second protrusion 130B. First protrusion 130A is consistent with the foregoing description of protrusion 130, and encompasses one of a substantially solid volume and a solid volume, lacking any sipe. Second protrusion 130B is consistent with the foregoing description of protrusion 130, and includes one or more sipes 128 that intersect second protrusion 130B.

First protrusion 130A and second protrusion 130B include first and second features, respectively, of each of the aforementioned features of protrusion 130. For example, first protrusion 130A includes a first top portion 132A having a first top surface 134A. A first radial surface 146A a first body portion 140A extends radially inward from first top surface 134A at a first angle. Second protrusion 130B includes a second top portion 132B having a second top surface 134B. A second radial surface 146B of second body portion 140B extends radially inward from second top surface 134B at a second angle. The respective first and second features of first protrusion 130A and second protrusion 130B may include one of substantially identical dimensions and different dimensions relative to one another.

As described above, sipe 128 may include any of a variety of configurations, including extending past block sidewall 116 into one or more of circumferential groove 120, axial groove 124, and an intersection of circumferential groove 120 and axial groove 124. Accordingly, sipe 128 may extend through block sidewall 116 of tread block 110 and continue extending into second protrusion 130B, such that sipe 128 intersects top portion 132 and body portion 140. Specifically, sipe 128 intersects top portion 132 and body portion 140, such that it extends through top portion 132 and body portion 140 to top surface 134 and radial surface 146, respectively.

Also described above, sipe 128 is radially oriented. In some examples, when sipe 128 extends into second protrusion 130B, it may extend to one of a circumferential groove base 122, an axial groove base 124, and an intersection of circumferential groove base 122 and an axial groove base 126. In other examples, when sipe 128 extends into second protrusion 130B, it may terminate before reaching one of a circumferential groove bottom 122, an axial groove bottom 124, and an intersection of circumferential groove bottom 122 and an axial groove bottom 126.

In one example, as illustrated in FIG. 3, sipe 128 extends such that it splits second protrusion 130B into halves, but does not extend to an intersection of circumferential groove bottom 122 and axial groove bottom 126. In another example, sipe 128 extends such that it splits second protrusion 130B into halves and extends to an intersection of circumferential groove bottom 122 and axial groove bottom 126. In a further example, a plurality of sipes 128 extend through second protrusion 130B such that they split it into a plurality of portions that are one of equal and unequal portions.

As tread 106 wears during use of tire 100, second protrusion 130B may correspondingly wear, which allows sipe 128 to provide additional traction edges of second protrusion 130B. As a result, traction performance of tread 106 is improved.

First and second protrusions 130A and 130B may be arranged along one or more block sidewalls 116 of one or more tread blocks 110 of one or more ribs 108. In one example, first protrusion 130A is positioned on a first block sidewall 116 of a tread block 110 of a first rib 108, and second protrusion 130B is positioned on a second block sidewall 116 of a tread block 110 of a second rib 108, such that second protrusion 130B is positioned substantially opposite to the first protrusion 130A. “Opposite” describes a second feature that is positioned such that it is a mirror image of a first feature along a desired line of reflection, which may be any orientation relative to any tire direction. In a similar example, each of a plurality of first protrusions 130A is positioned on a first block sidewall 116 of each of a plurality of tread blocks 110 of a first rib 108, and each of a plurality of second protrusions 130B is positioned on a second block sidewall 116 of each of a plurality of tread blocks 110 of a second rib 108, such that each second protrusion 130B is positioned substantially opposite to a corresponding first protrusion 130A. In either example, first rib 108 and second rib 108 are one of a shoulder rib and a contiguous intermediate rib, and an intermediate rib and a contiguous center rib.

In another example, first protrusion 130A is positioned on a substantially axially outward-facing block sidewall 116 of a tread block 110 of one of a plurality of ribs 108, and second protrusion 130B is positioned on a substantially axially inward-facing block sidewall 116 of a tread block 110 of a contiguous rib 108, such that second protrusion 130B is positioned substantially opposite to first protrusion 130A. In a similar example, each of a plurality of first protrusions 130A is positioned on a substantially axially outward-facing block sidewall 116 of each of a plurality of tread blocks 110 of one of a plurality of ribs 108. Also, each of a plurality of second protrusions 130B is positioned on a substantially axially inward-facing block sidewall 116 of each of a plurality of tread blocks 110 of a contiguous rib 108, such that second protrusion 130B is positioned substantially opposite to first protrusion 130A.

In a further example, first protrusion 130A is positioned on a diagonal and substantially outward-facing block sidewall 116 of a tread block 110 of an intermediate rib 108, and second protrusion 130B is positioned on a diagonal and substantially inward-facing block sidewall 116 of a contiguous shoulder rib 108, such that second protrusion 130B is positioned substantially opposite to first protrusion 130A. In a similar example, each of a plurality of first protrusions 130A is positioned on a diagonal and substantially outward-facing block sidewall 116 of each of a plurality of tread blocks 110 of an intermediate rib 108. Also, each of a plurality of second protrusions 130B is positioned on a diagonal and substantially inward-facing block sidewall 116 of each of a plurality of tread blocks 110 of a contiguous shoulder rib 108, such that second protrusion 130B is positioned substantially opposite to first protrusion 130A.

In a similar example, as illustrated in FIG. 2, each of a plurality of first protrusions 130A is positioned on a diagonal and substantially outward-facing block sidewall 116 of each of a plurality of tread blocks 110 of an intermediate rib 108. The diagonal and substantially outward-facing block sidewall 116 is oriented such that it faces a triangular-shaped high void area. Also, each of a plurality of second protrusions 130B is positioned on a diagonal and substantially inward-facing block sidewall 116 of each of a plurality tread block 110 of a contiguous shoulder rib 108. The diagonal and substantially inward-facing block sidewall 116 of tread block 110 of intermediate rib 108 is oriented such that it faces an opposing triangular-shaped high void area. The triangular-shaped high voids areas are formed at opposing intersections of a circumferential groove 120 and an axial groove 124. Further, each second protrusion 130B is positioned substantially opposite to a corresponding first protrusion 130A.

In an additional example, first protrusion 130A is positioned on a diagonal and substantially outward-facing block sidewall 116 of a tread block 110 of a center rib 108, and second protrusion 130B is positioned on a diagonal and substantially inward-facing block sidewall 116 of a contiguous intermediate rib 108, such that second protrusion 130B is positioned substantially opposite to first protrusion 130A. In a similar example, each of a plurality of first protrusions 130A is positioned on a diagonal and substantially outward-facing block sidewall 116 of each of a plurality of tread blocks 110 of a center rib 108. Also, each of a plurality of second protrusions 130B is positioned on a diagonal and substantially inward-facing block sidewall 116 of each of a plurality of tread blocks 110 of a contiguous intermediate rib 108, such that second protrusion 130B is positioned substantially opposite to first protrusion 130A.

In any of the foregoing examples, each first and second protrusion 130A and 130B has a top surface 134 that is radially offset from each block tread surface 116. In addition, first protrusion 130A and second protrusion 130B may interchange positions. Furthermore, in any of the aforementioned examples, a plurality of first protrusions 130A and a plurality of second protrusions 130B may be included on each block sidewall 116. Also, any of the prior examples may be applied to any and all block sidewalls 116 of any rib 108 of tread 106.

Referring to FIGS. 2, 3, 7, and 10, tread 106 may further include one or more ridges 150. Ridge 150 may be formed into one or more block sidewalls 116 of one or more tread blocks 110. Ridge 150 may be created by a valley 152 formed into block sidewall 116 on either side of ridge 150, such that ridge 150 appears to protrude from block sidewall 116, but instead extends to a boundary of block sidewall 116. Valley 152 may include a valley surface 154. Ridge 150 creates enhanced edges for traction, particularly snow-on-snow traction in tread 106. In addition, ridge 150 functions to entrap snow in tread 106 to increase snow-on-snow traction. Ridge 150 also adds visual interest to tread 106 to increase a perception of snow traction.

Ridge 150 may include any of a variety of arrangements on block sidewall 116. In one example, ridge 150 is formed into a block sidewall 116 that faces circumferential groove 120. In another example, ridge 150 is formed into a block sidewall 116 that faces axial groove 124. In a further example, ridge 150 is formed into a block sidewall 116 that faces an intersection of circumferential groove 120 and axial groove 124, including a high void area. In another example, a plurality of ridges 150 is formed into each of a plurality of block sidewalls 116 that faces circumferential groove 120. In an additional example, a plurality of ridges 150 is formed into each of a plurality of block sidewalls 116 that faces axial groove 124. In another example, a plurality of ridges 150 is formed into each of a plurality of block sidewalls 116 that an intersection of circumferential groove 120 and axial groove 124. In a further example, as shown in FIG. 2, a plurality of ridges 150 is formed into a plurality of block sidewalls 116 that faces into an outermost circumferential groove 120 and corresponding intersections of the outermost circumferential groove 120 and a plurality of axial groove 124.

In examples where block sidewall 116 includes a plurality of ridges 150, the plurality of ridges 150 is adapted to fit an individual block sidewall 116, such that the plurality of ridges 150 is aligned to a center of a length of block sidewall 116.

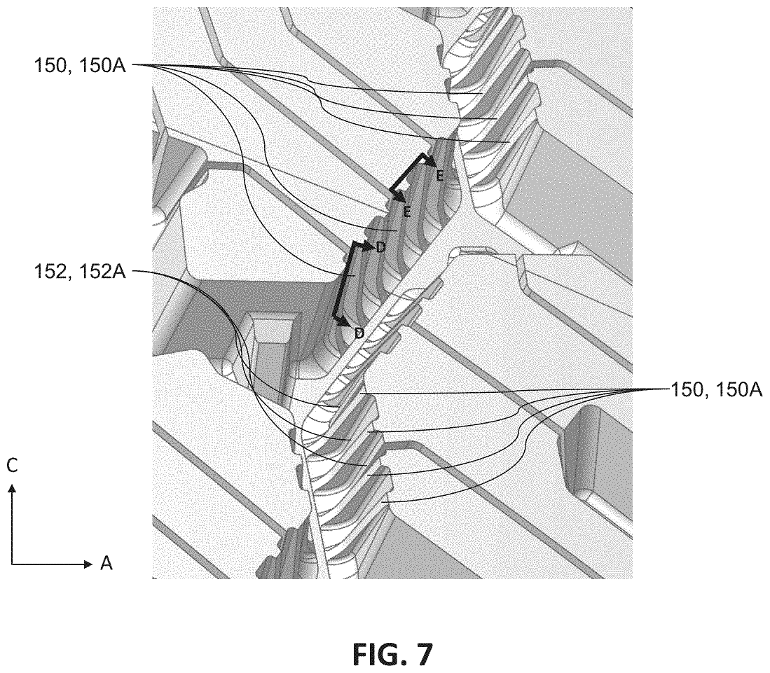

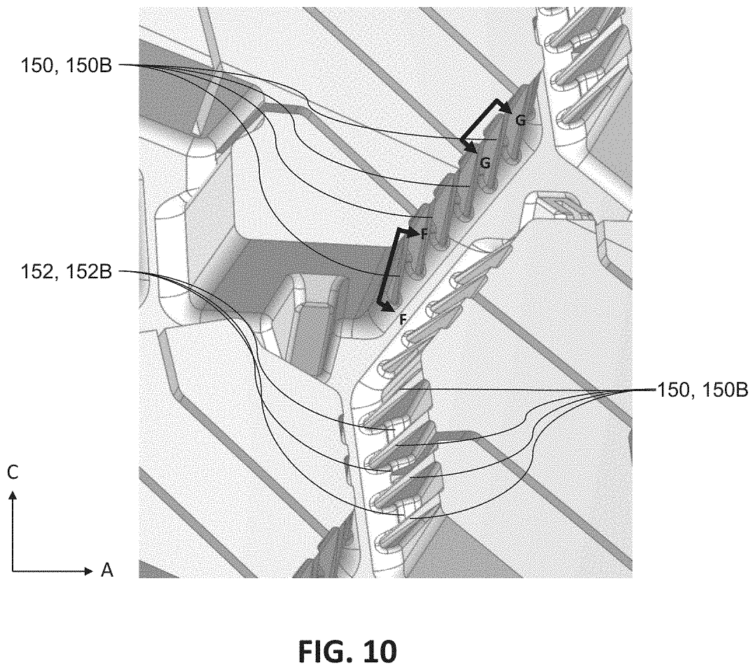

Referring to FIGS. 7 and 10, ridge 150 may include two types of ridges, a first ridge 150A and a second ridge 150B. First ridge 150A and second ridge 150B are consistent with the foregoing description of ridge 150. Likewise, valley 152 may include two types of valleys, a first valley 152A having a first valley surface 154A, and a second valley 152B having a second valley surface 154B, which are also consistent with the foregoing description.

First ridge 150A and second ridge 150B may include a height H_{R1} and a height H_{R2}, respectively. Heights H_{R1} and H_{R2} are a distance from block tread surface 112 radially inwardly along P_{T1} to block base 124. Thus, first ridge 150A and second ridge 150B extend along the entire height H_{S} of block sidewall 116. In addition, as first valley 152A and second valley 152B form first ridge 150A and second ridge 150B, respectively, heights H_{R1} and H_{R2} may correspond to a height of first valley 152A and second valley 152B, respectively.

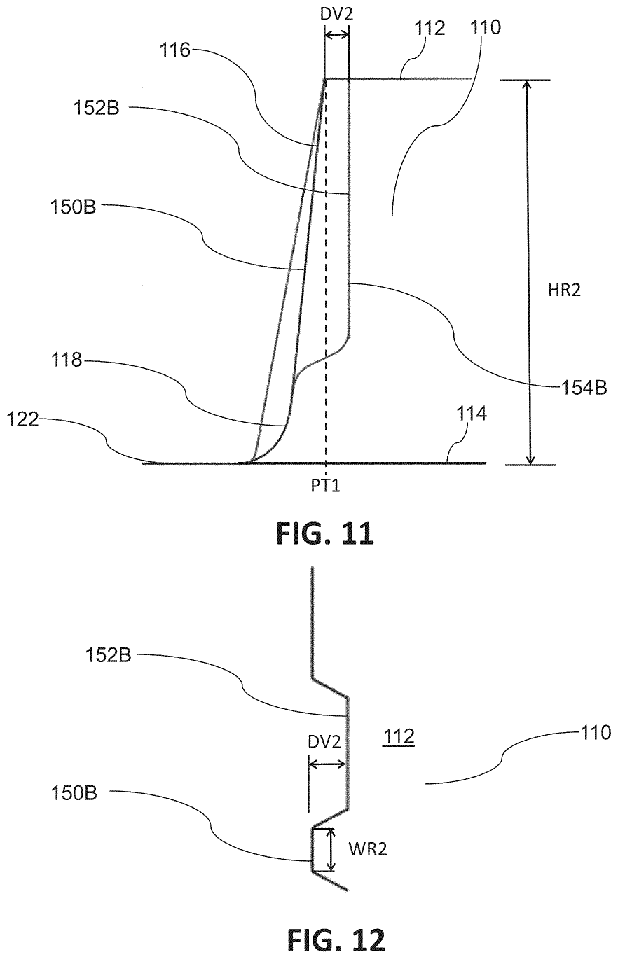

In addition, referring to FIGS. 9 and 11, first ridge 150A and second ridge 150B may include a width W_{R1} and W_{R2}, respectively. Comparatively, width W_{R2} of second ridge 150B where second ridge 150B meets block base 124 is greater than width W_{R1} of first ridge 150A where first ridge 150A meets block base 124. In addition, width W_{R2} of second ridge 150B at block tread surface 112 is narrower than width W_{R1} of first ridge 150A at block tread surface 112. As a result, it prevents second ridge 150B from getting damaged, provides greater stability, and creates deeper pockets between second ridges 150B to allow for more snow to be trapped.

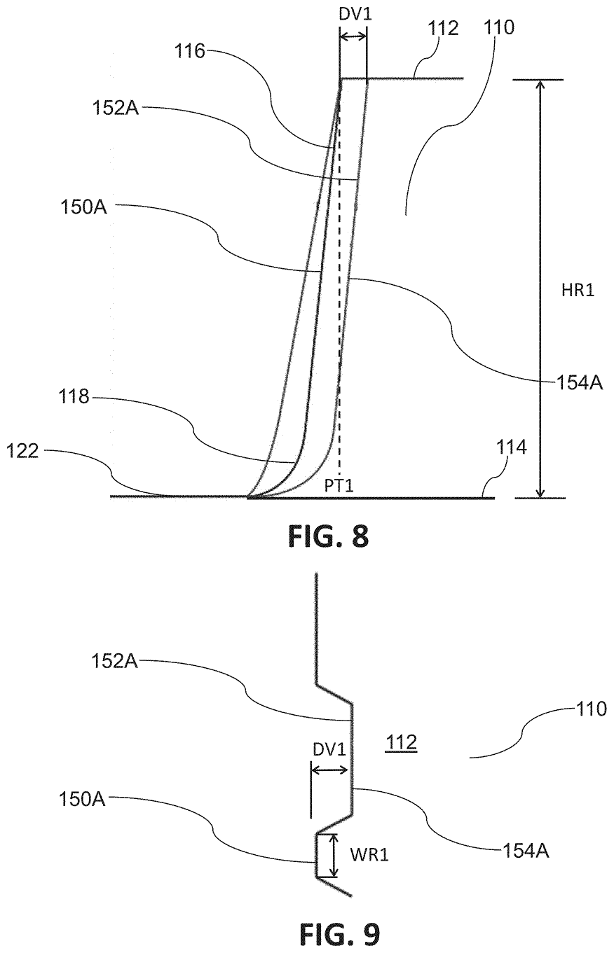

First valley 152A may define first ridge 150A. Specifically, a first valley 152A may be included on either side of first ridge 150A so as to form first ridge 150A. First valley 152A may include a depth D_{V1}. As shown in FIGS. 8 and 9, depth D_{V1} is a distance from plane P_{T1} to first valley surface 154A. Depth D_{V1} may be one of constant, increase at a constant rate, or decrease at a constant rate along height H_{R1} of first valley 152A. In one example, as seen in FIGS. 8 and 9, depth D_{V1} is constant along height H_{R1}.

Also, as illustrated in FIGS. 8 and 9, depth D_{V1} may be taken at tread block surface 112. In one example, depth D_{V1} at tread block surface 112 is about 0.8 mm. In another example, depth D_{V1} at tread block surface 112 is 0.8 mm.

Second valley 152B may define first ridge 150B. Specifically, a second valley 152B may be included on either side of second ridge 150B so as to form second ridge 150B. Second valley 152B may include a depth D_{V2}. As shown in FIGS. 11 and 12, depth D_{V2} is a distance from plane P_{T1} to second valley surface 154B. Depth D_{V2}. may vary along height H_{R2} of second valley 152B. In one example, as shown in FIGS. 10 and 11, depth D_{V2} remains constant along a radially outer portion of second valley 152B, and varies along a radially inner portion of second valley 152B.

Also illustrated in FIGS. 11 and 12, depth D_{V2} may be taken at tread block surface 112. In one example, depth D_{V2} at tread block surface 112 is about 0.0 mm. In another example, depth D_{V1} at tread block surface 112 is 0.0 mm.

What have been described above are examples. It is, of course, not possible to describe every conceivable combination of components or methods, but one of ordinary skill in the art will recognize that many further combinations and permutations are possible. Accordingly, the disclosure is intended to embrace all such alterations, modifications, and variations that fall within the scope of this application, including the appended claims. Additionally, where the disclosure or claims recite “a,” “an,” “a first,” or “another” element, or the equivalent thereof, it should be interpreted to include one or more than one such element, neither requiring nor excluding two or more such elements. As used herein, the term “includes” means includes but not limited to, and the term “including” means including but not limited to the term “based on” means based at least in part on.

What is claimed is:

1. A tire comprising:
a tread having:
a first rib;
a second rib;
a plurality of axial grooves that traverse each rib, dividing each rib into a plurality of tread blocks,
wherein each tread block includes one or more block sidewalls and a block tread surface;
a circumferential groove positioned between the first rib and the second rib, the circumferential groove having a groove bottom bound by the one or more block sidewalls;
a first protrusion positioned on a first block sidewall of a tread block of the first rib,
wherein the first protrusion has a first top surface, and the first top surface is radially offset from the block tread surface,
wherein the first protrusion has a first radial surface that extends radially inward from the first top surface at an angle θ_{R1}; and
a second protrusion positioned on a second block sidewall of a tread block of the second rib,
wherein the second protrusion has a second top surface, and the second top surface is radially offset from the block tread surface,
wherein the second protrusion has a second radial surface that extends radially inward from the second top surface at an angle θ_{R2}, and
wherein the second protrusion is positioned substantially opposite to the first protrusion.

2. The tire of claim 1, further comprising a plurality of first protrusions, wherein a first protrusion is positioned on the first block sidewall of each tread block of the first rib.

3. The tire of claim 2, further comprising a plurality of second protrusions, wherein a second protrusion is positioned on the second block sidewall of each tread block of the second rib.

4. The tire of claim 1, wherein the first protrusion is solid.

5. The tire of claim 1, wherein the second protrusion includes a sipe.

6. The tire of claim 1, wherein at least one of the first protrusion and the second protrusion is positioned at an intersection of one of the plurality of axial grooves and the circumferential groove.

7. A tire comprising:
a tread having:
a plurality of ribs;
a plurality of axial grooves that traverse each rib, dividing each rib into a plurality of tread blocks,
wherein each tread block includes one or more block sidewalls and a block tread surface, and
wherein each of the one or more block sidewalls includes one or more of a substantially axially outward-facing sidewall and one or more of a substantially axially inward-facing sidewall;
a plurality of circumferential grooves, each having a circumferential groove bottom bound by the one or more block sidewalls,
wherein each of the plurality of circumferential grooves is positioned between two contiguous ribs;
a first protrusion positioned on the substantially axially outward-facing block sidewall of a tread block one of the plurality of ribs,
wherein the first protrusion has a first top surface, and the first top surface is radially offset from the block tread surface, and
wherein the first protrusion has a first radial surface that extends radially inward from the first top surface at an angle θ_{R1}; and
a second protrusion positioned on the substantially axially inward-facing block sidewall of a tread block of a contiguous rib,
wherein the second protrusion has a second top surface, and the second top surface is radially offset from the block tread surface,
wherein the second protrusion has a second radial surface that extends radially inward from the second top surface at an angle θ_{R2}, and
wherein the second protrusion is positioned substantially opposite to the first protrusion.

8. The tire of claim 7, further comprising a plurality of first protrusions, wherein a first protrusion is positioned on the substantially axially outward-facing block sidewall of each tread block of the one of the plurality of ribs.

9. The tire of claim 7, further comprising a plurality of second protrusions, wherein a second protrusion is positioned on the substantially axially inward-facing block sidewall of each tread block of the contiguous rib.

10. The tire of claim 7, wherein the first protrusion is solid.

11. The tire of claim 7, wherein the second protrusion includes a sipe.

12. The tire of claim 8, wherein the one of the plurality of ribs is a shoulder rib.

13. The tire of claim 12, wherein the contiguous rib is an intermediate rib.

14. The tire of claim 7, wherein at least one of the first protrusion and the second protrusion is positioned at an intersection of one of the plurality of axial grooves and one of the plurality of circumferential grooves.

15. A tire comprising:
a tread having:
opposing shoulder ribs;
opposing intermediate ribs;
a plurality of axial grooves that traverse each rib, dividing each rib into a plurality of tread blocks,
wherein each tread block includes one or more block sidewalls and a block tread surface, and
wherein each of the one or more block sidewalls includes one or more of a diagonal and substantially outward-facing block sidewall and one or more of a diagonal and substantially inward-facing block sidewall;
a plurality of circumferential grooves, each having a circumferential groove bottom bound by the one or more block sidewalls,
wherein each of the plurality of circumferential grooves is positioned between each shoulder rib and each contiguous intermediate rib;
a first protrusion positioned on the diagonal and substantially outward-facing block sidewall of a tread block of each intermediate rib; and
wherein the first protrusion has a first top surface, and the first top surface is radially offset from the block tread surface, and
wherein the first protrusion has a first radial surface that extends radially inward from the first top surface at an angle θ_{R1}; and
a second protrusion positioned on the substantially diagonal and inward-facing block sidewall of a tread block of each shoulder rib,
wherein the second protrusion has a second top surface, and the second top surface is radially offset from the block tread surface,
wherein the second protrusion has a second radial surface that extends radially inward from the second top surface at an angle, and
wherein the second protrusion is positioned substantially opposite to the first protrusion.

16. The tire of claim 15, further comprising a plurality of first protrusion, wherein a first protrusion is positioned on the diagonal and substantially outward-facing block sidewall of each tread block of each circumferential intermediate rib.

17. The tire of claim 15, further comprising a plurality of second protrusions, wherein a second protrusion is positioned on the diagonal and substantially inward-facing sidewall of each tread block of each circumferential shoulder rib.

18. The tire of claim 15, wherein the first protrusion is solid.

19. The tire of claim 15, wherein the second protrusion includes a sipe.

20. The tire of claim 15, wherein at least one of the first protrusion and the second protrusion is positioned at an intersection of one of the plurality of axial grooves and one of the plurality of circumferential grooves.
